(19) United States
(12) Patent Application Publication
(10) Pub. No.: US 2010/0253058 A1
(43) Pub. Date: Oct. 7, 2010

(54) Login and password address book

(75) Inventor: Anita Ingersoll, Carlsbad, CA (US)

Correspondence Address: ANITA INGERSOLL, 2850 ENGLEWOOD WAY, CARLSBAD, CA, 92010, US

(73) Assignee: Anita Ingersoll, Carlsbad, CA (US)

(21) Appl. No.: 12/657,993

(22) Filed: Mar. 5, 2010

(51) Int. Cl. B42D 1/00

(52) U.S. Cl. 281/15.1

(57) ABSTRACT

This address book is new and unique as it will be functioning as a storage of only internet addresses and information pertaining to and or necessary for usage of a website. The titles for recording line items are; name, login, password, and URL.

### DESCRIPTION OF INVENTION

This is an address book can be either hard copy or paperback. The inside pages are alphabetized and have lines with headings that are for recording one's internet URLs, logins and passwords.

### LIST OF FIGURES

### Alphabetized Pages From A To Z

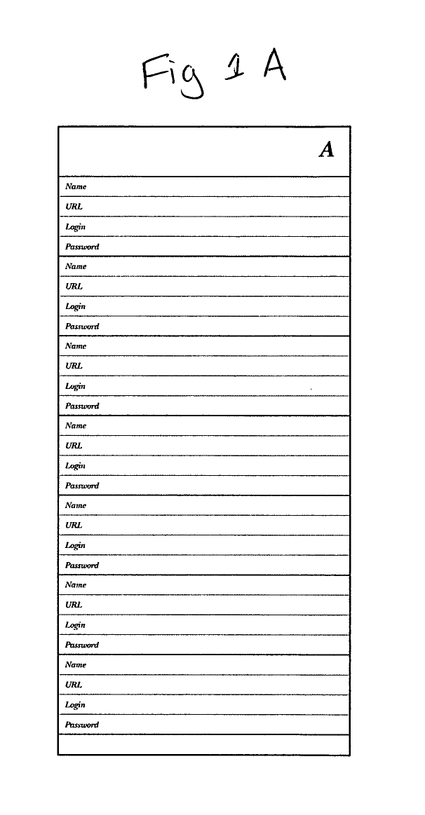

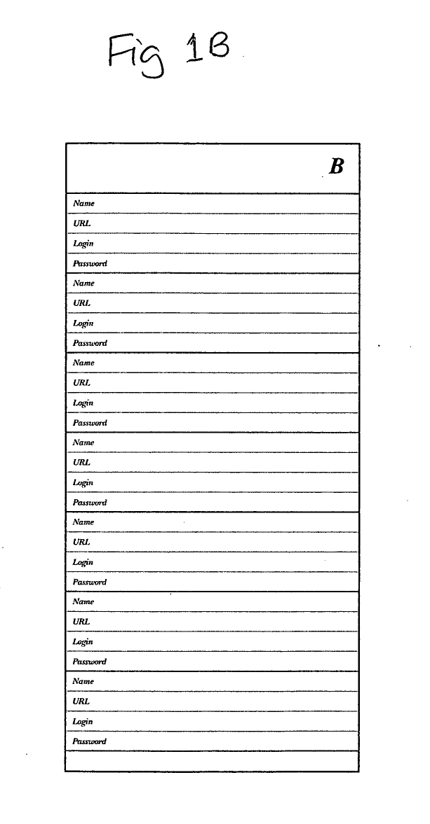

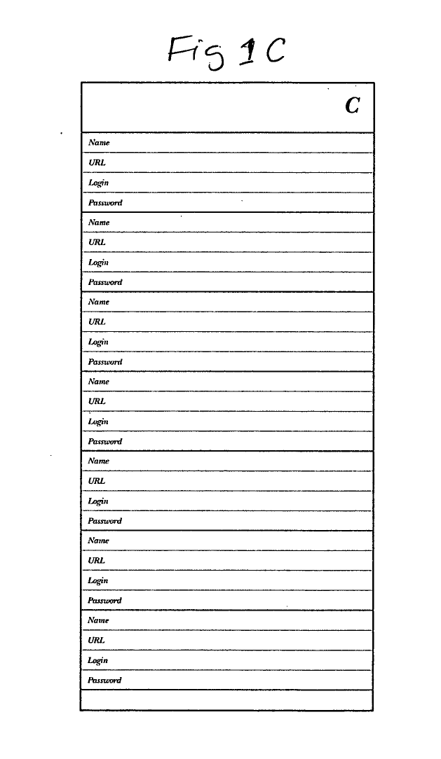

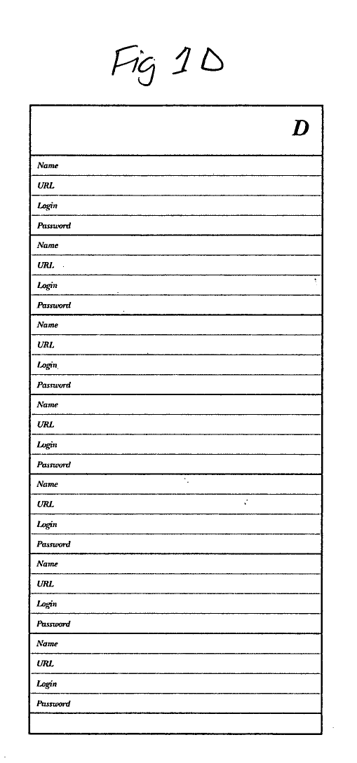

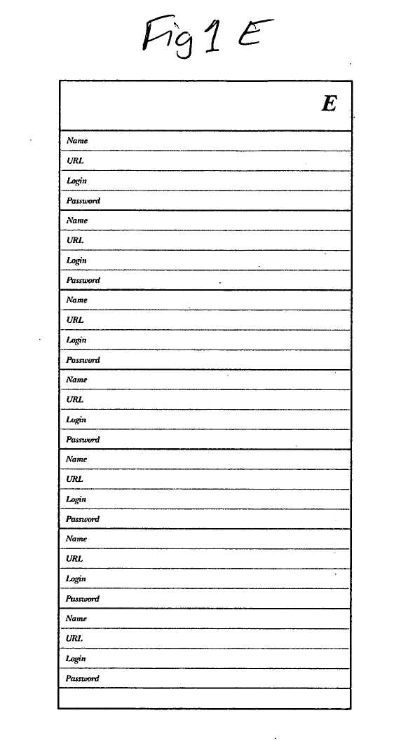

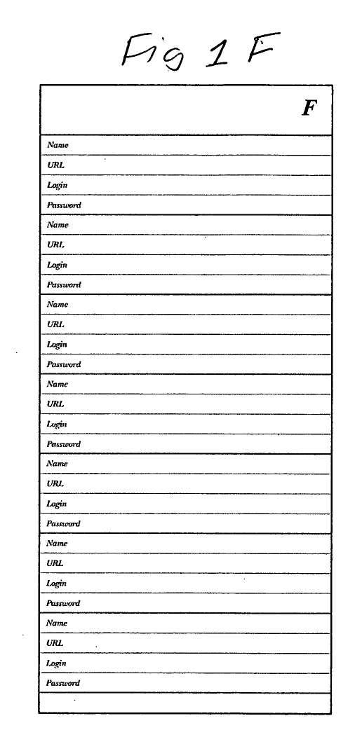

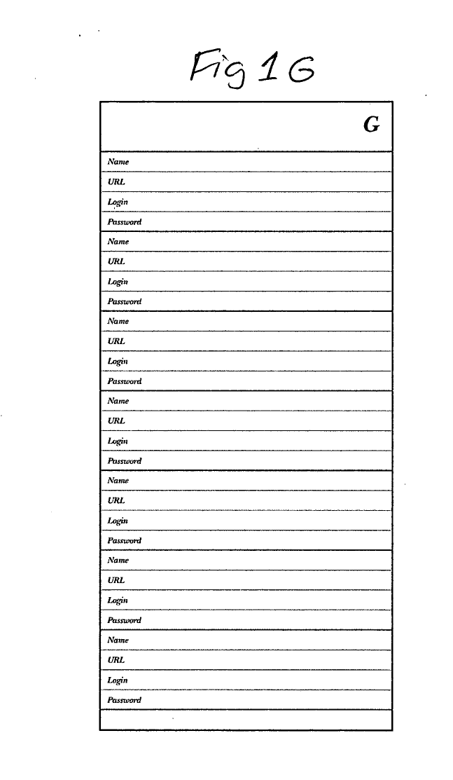

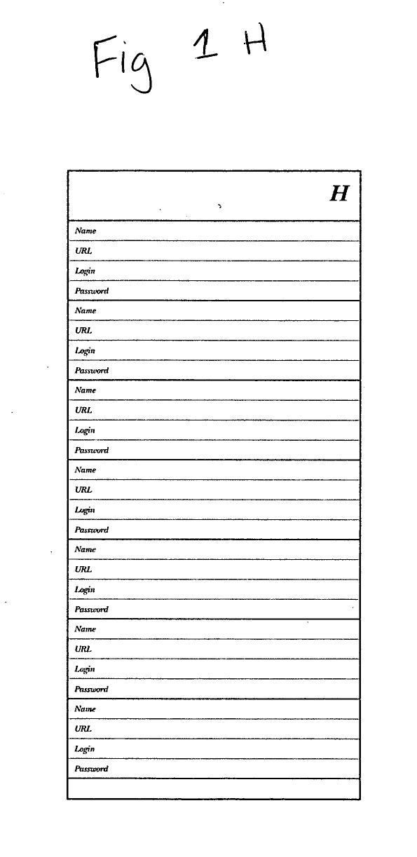

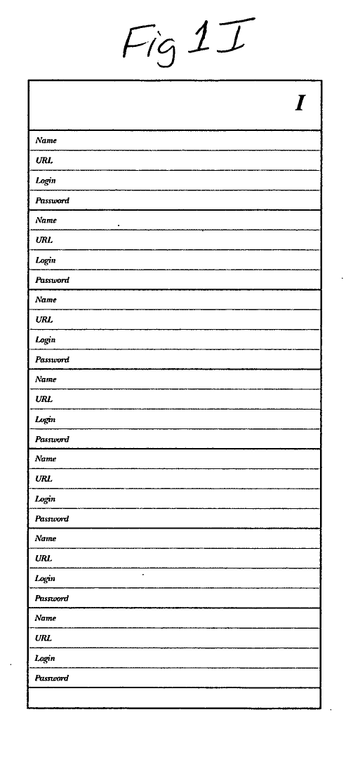

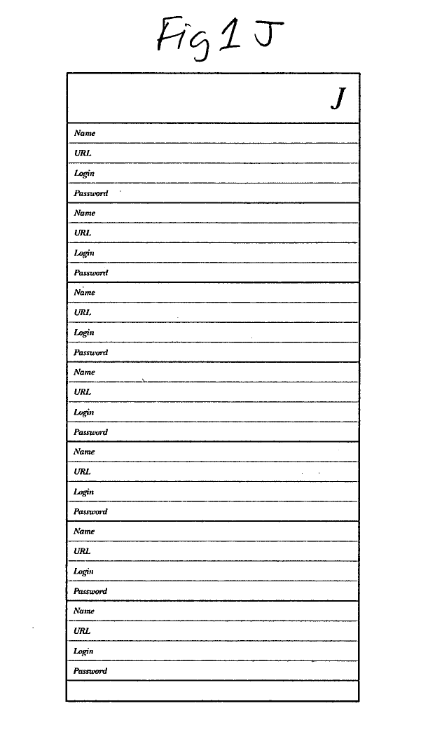

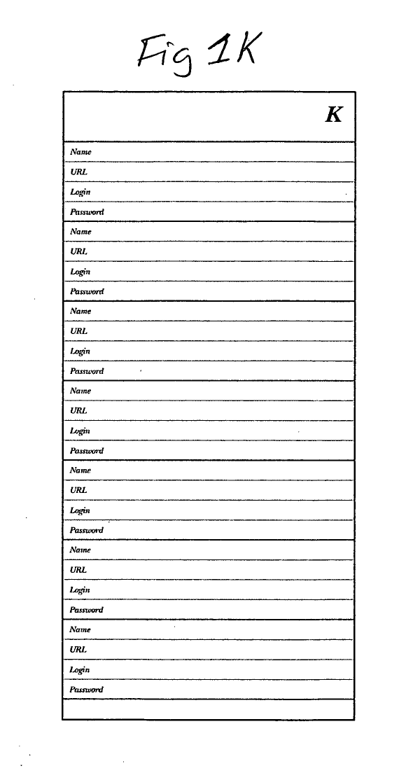

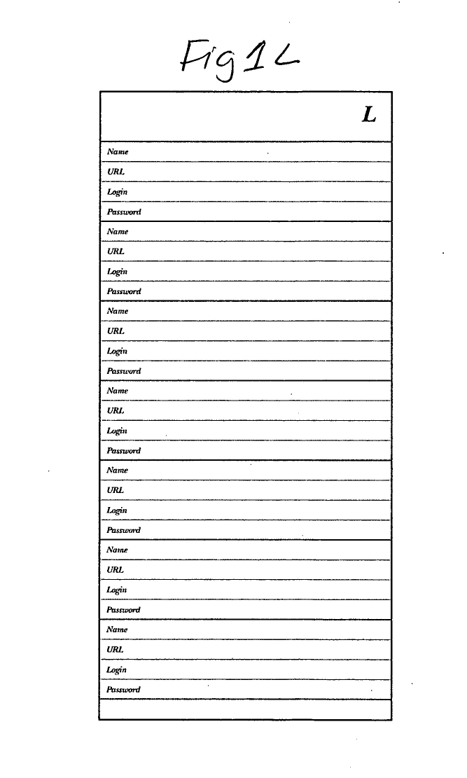

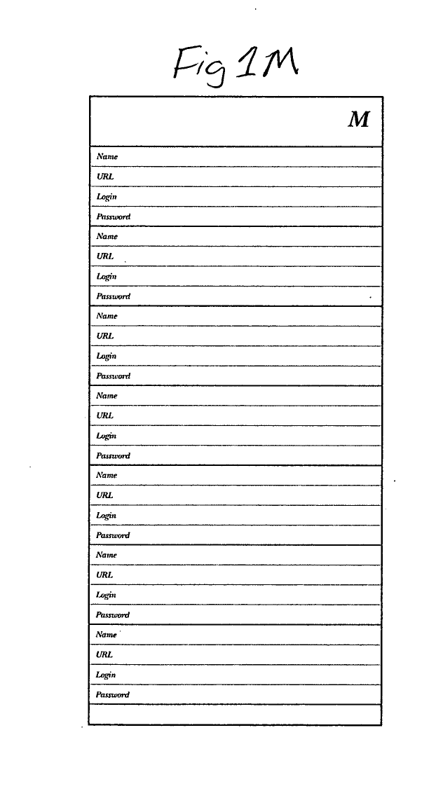

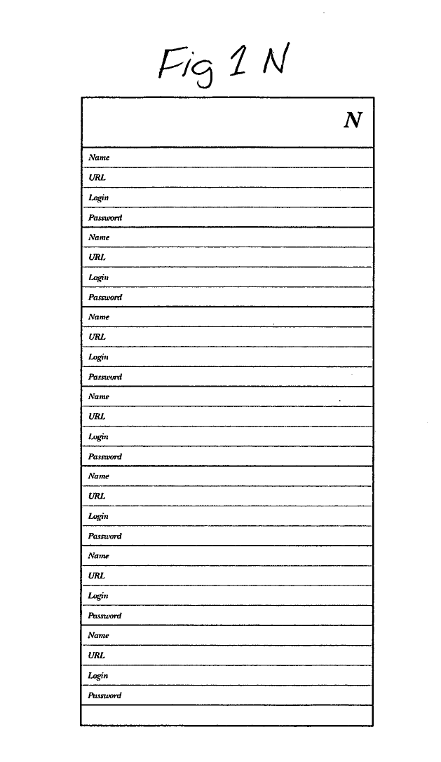

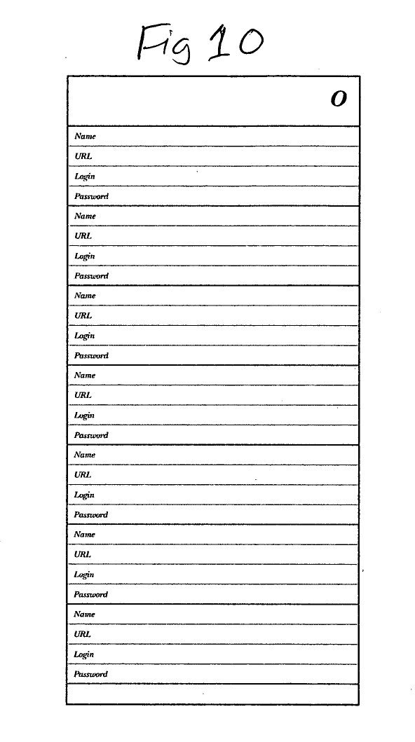

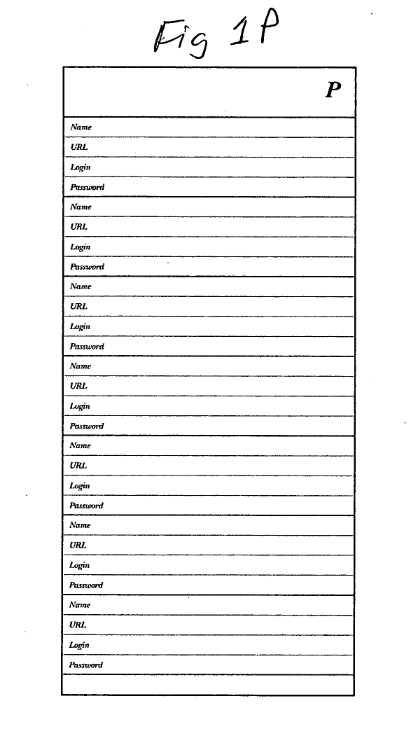

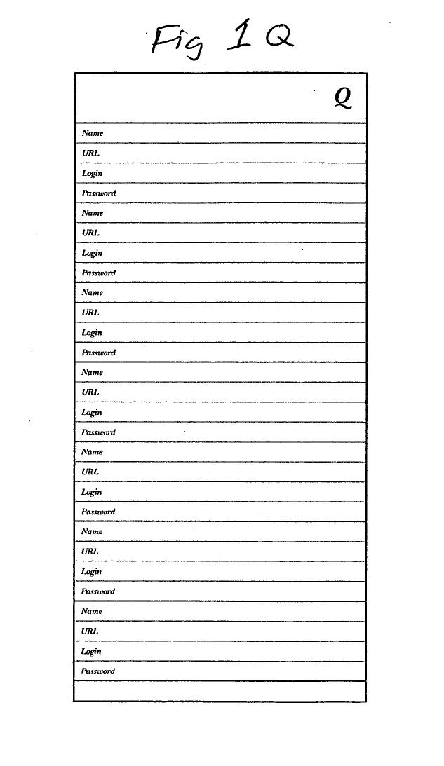

FIG. 1A, 1B, 1C, 1D, 1E, 1F, 1G, 1H, 1I, 1J, 1K, 1L, 1M, 1N, 1O, 1P, 1Q, 1R, 1S, 1T, 1U, 1V, 1W, 1X, 1Y, 1Z

### Lines With Space To Write the Appropriate Information

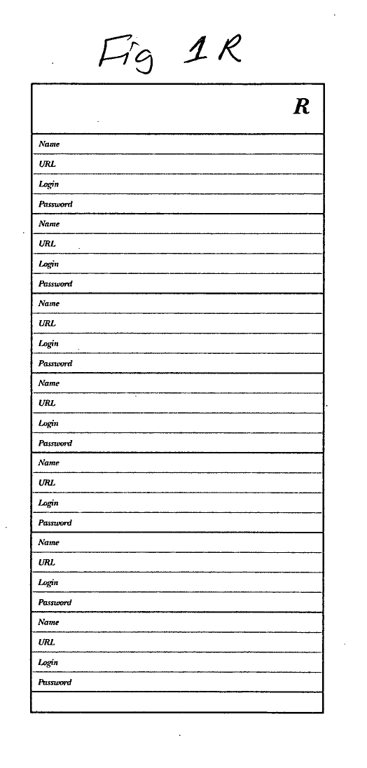

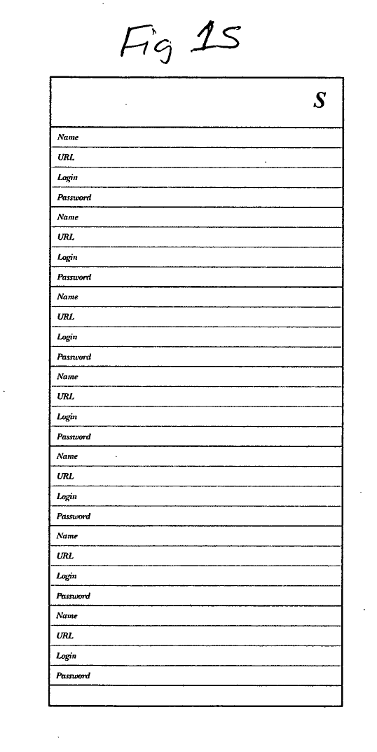

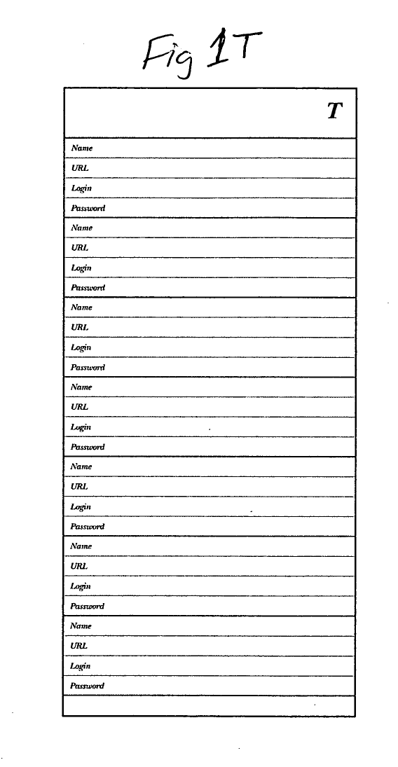

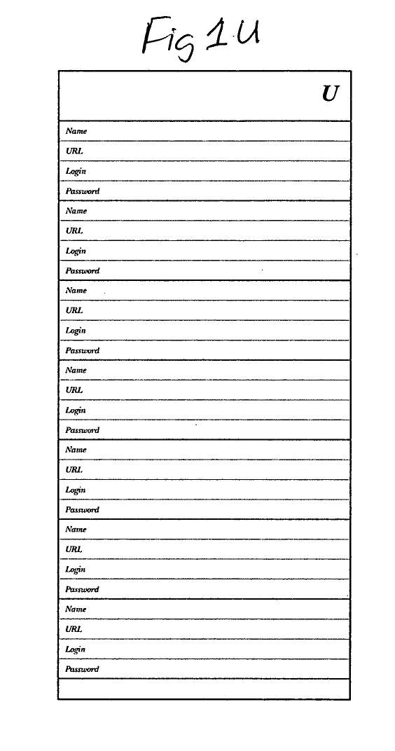

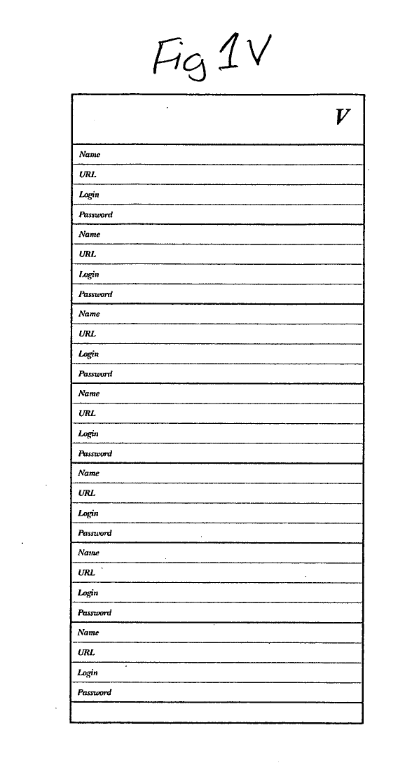

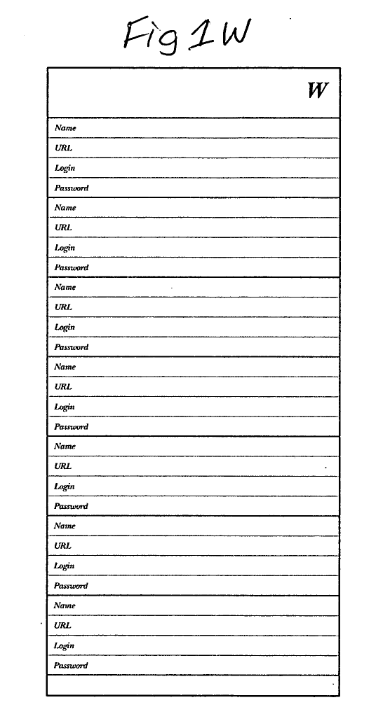

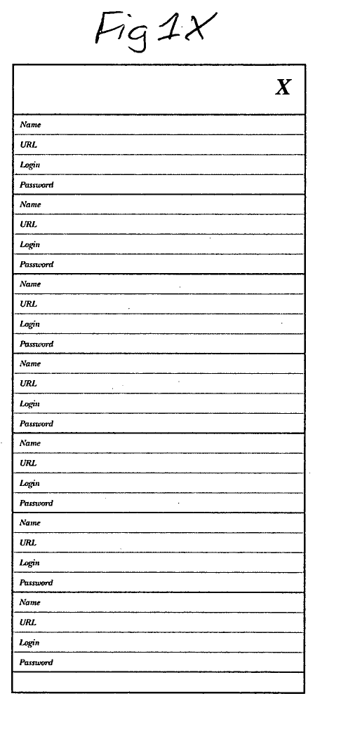

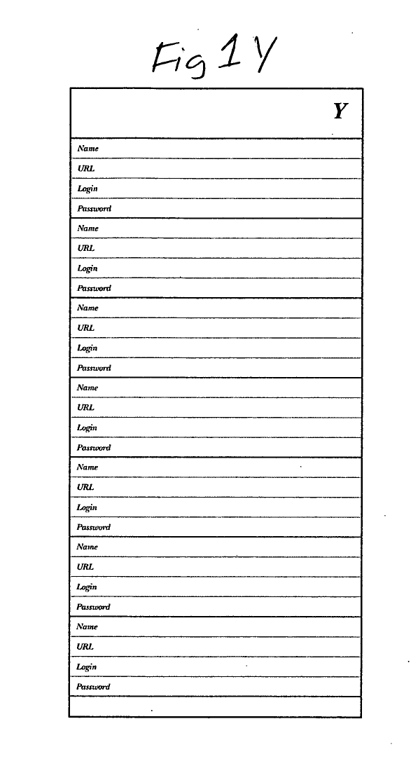

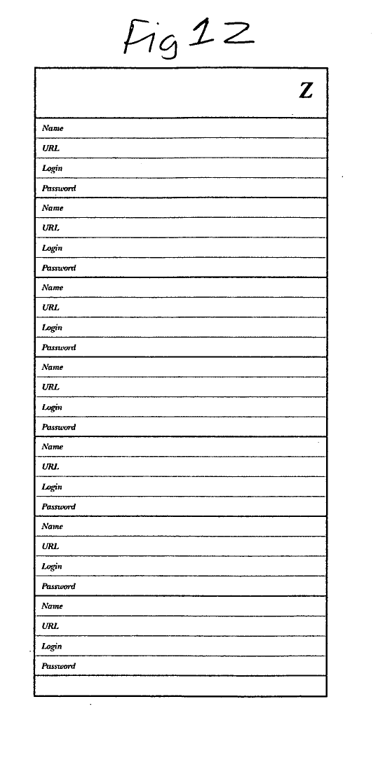

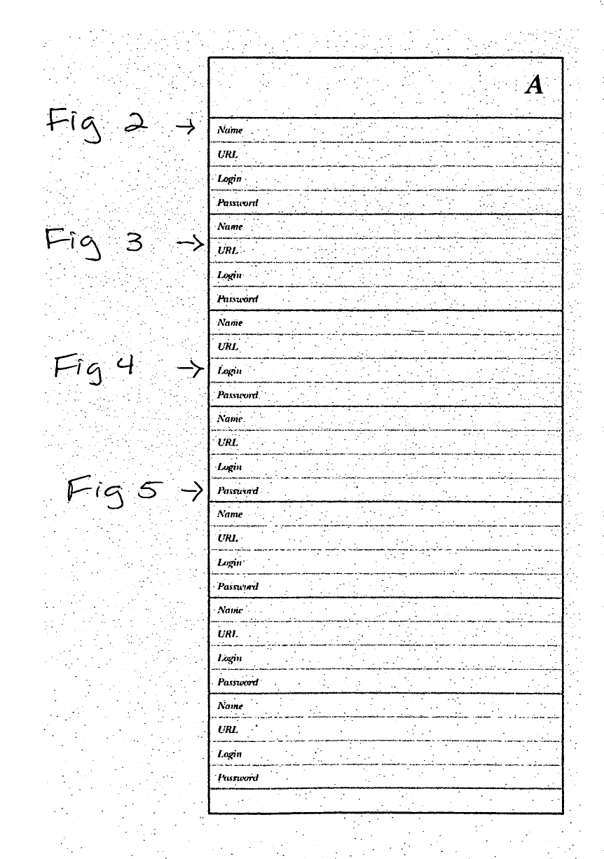

FIG. 2 Name

FIG. 3 URL

FIG. 4 Login

FIG. 5 Password

1. This invention is the only address book on the market that will be used exclusively for recording, storing, and organization of one's internet passwords, logins and URLs.
